(19) United States
(12) Patent Application Publication
(10) Pub. No.: US 2005/0027567 A1
(43) Pub. Date: Feb. 3, 2005

(54) System and method for health care data collection and management

(76) Inventor: Amer Jamil Taha, League City, TX (US)

Correspondence Address: Jonathan P. Osha;Osha & May L.L.P., Suite 2800, 1221 McKinney Street, Houston, TX, 77010, US

(21) Appl. No.: 10/900,911

(22) Filed: Jul. 28, 2004

Related U.S. Application Data
(60) Provisional application No. 60/490,735, filed on Jul. 29, 2003.

(51) Int. Cl. G06F 17/60

(52) U.S. Cl. 705/2

(57) ABSTRACT

A health care system including a field module configured to gather a first portion of patient data and to send the first portion of patient data to a server, an administrative module configured to perform a plurality of functions on patient data, and a physician module configured to display patient data and perform a patient care function.

### CROSS-REFERENCE TO RELATED APPLICATIONS

This application claims benefit of U.S. Provisional Application 60/490,735 entitled “System and Method For Health Care Data Collection and Management,” filed Jul. 29, 2003, under 35 U.S.C. § 119(e), the contents of which is incorporated by reference.

### BACKGROUND OF INVENTION

Home health care systems are becoming increasingly important in today's modern health care industry. Home health care systems center around chronically ill patients admitted to a home health care agency or managed by a clinical case management group and cared for by a home health care team that typically includes physicians practicing in their own offices or a hospital, nurses, therapists, home care management and quality improvement team, as well as in-office and administrative support specialists. A common goal of home health care and other care management groups is allowing the patient to live in his or her own natural environment easily without the need to continuously seek hospitalization and institutional care, which is generally costly, less conducive to healing, and many times more isolating in nature.

Because members of the home care team are typically separated from each other, and separated from the charts and records for patients and in order to accomplish the goals of home health care, considerable attention must be given to managing and controlling the flow of patient information for each given patient. The patient information includes information regarding assessments of the patient condition, clinical intervention in the patient care, and documented responses of patients to treatment and progress of the patient health condition (e.g., the patient's current physical/mental condition, and physiological data, such as blood pressure, lab results and documented observation and progress notes, etc.). Thus, an essential requirement is that everyone involved in caring for the patient (i.e., the entire care management and/or home health care team) is timely apprised of the condition and progress of the patient with as much detail as possible. In order to effectively manage and control the patient information, home health care agencies and care management teams are turning to high technology solutions, including a variety of computer technologies.

One issue of concern to designers of technology-oriented solutions for the needs of home health care agencies and care management groups is that of time lapses in the delivery and updating of patient information. Another such issue of concern is overwriting of information in patient records and resolution of conflicting information in patient records arriving from different entities and various locations. Other issues concerning designers of computer technology solutions for home health care and care management groups is handling patient data collection needs for different patients in different situations or other environments or situations not conducive to collecting patient information. For example, handling patient data collection for patients living in homes without internet or telephone connectivity, or for patients who are disabled, and do not have anyone to help them collect and communicate patient health care information.

FIG. 1 shows a flow diagram of a currently used communications network for a few home health care systems or care management groups. A patient computerized unit (20) is located in the residence of a home patient, and connected to a telemonitoring data collection kit (22) via a serial port cable (24). The telemonitoring data collection kit (22) collects physiological data, such as heartbeat rate, body temperature, etc. The data collected by the telemonitoring data collection kit (22) is then transferred to and stored on the patient computerized unit (20). Next, the patient computerized unit (20) is connected via a first telephone connection (26) to a server (28) housing a database (30), which stores patient data (32) for the home health care patient using data transferred from the patient computerized unit (20). Medical professional station 1 (34) is connected to the server (28) via a second telephone connection or internet (36). Likewise, medical professional station 2 (38) is connected to the server (28) via a third telephone connection or Internet (40).

In some instances, medical professionals, such as doctors and nurses, may use the medical professional station 1 (34) and/or medical professional station 2 (38) in an on-demand basis to access the patient data and analyze the data therein in order to determine the condition of the patient. Additionally, appropriate video equipment (not shown) may be used to arrange videoconferencing between the medical professionals at medical professional station 1 (34) and medical professional station 2 (38) and the home health care patient using the patient computerized unit (20). Medical professional station 1 (34) and/or medical professional station 2 (38) are remote facilities separate from the location of the patient. Generally, the health care system described above is commonly referred to as a form of telemedicine. Certain events are common to home health care situations. FIG. 2 shows a flowchart including a common sequence of such events. Initially, a physician or another health care professional (such as a home health nurse) obtains specific patient data from a database via a medical professional station (Step 50). Once the physician (or other health care professional) receives the patient information, the data in analyzed (Step 52). Next, a physician order for intervention is provided (usually by telephone) to the home health care agency (Step 54). For example, a physician may place a telephone call to order that a nurse collect fasting blood sugar for a patient, or that a physical therapist make a safety evaluation of a specific patient's residence.

Once the physician order is received by the home health care agency or the care management group, the physician order is disseminated to the home health care agency team via traditional electronic communication devices (e.g., pagers, cell phones, etc.) (Step 56). For example, the home health care agency may contact the nurse or physical therapist to set up a regular visit for the specified patient based on the physician order. Next, the patient data is modified at the medical professional station or by support team (at the care management group's office) to reflect the physician order (Step 58), and then the physician order is printed out (or written out by hand) (Step 60). The physician order is then delivered (e.g., by postal mail, courier, etc) to the physician for signature (Step 62). When the physician receives the physician order, he or she signs it and mails the physician order back to the home health agency (Step 64). The physician then makes copies of the physician order and retains it in a physician office record for the patient (Step 66).

Complying with the constantly changing rules and regulatory standards controlling health care practices as well as home health agencies and other managing health care entities (on a local, state, and national level) is becoming extremely burdensome. Not only does the federal government require that participating home health care agencies and other health care entities conform to Medicare care standards, but new regulatory acts, such as the Health Insurance Portability and Accountability Act (HIPAA) of 1996, regulate the means in which all health care entities receive, transmit, and maintain healthcare information in a secured and safeguarded manner. HIPAA addresses various health care areas, such as how insurance claims are submitted, how patient records are maintained and communicated, how patient consent and authorization forms are maintained, and how referrals are given or received, etc. Failure to comply with regulatory standards, such as HIPAA, may lead to fines and other penalties for all health care entities and practitioners.

### SUMMARY OF INVENTION

In general, in one aspect, the invention relates to a health care system. The health care system includes a field module configured to gather a first portion of patient data and to send the first portion of patient data to a server, an administrative module configured to perform a plurality of functions on patient data, and a physician module configured to display patient data and perform a patient care function.

In general, in one aspect, the invention relates to a method of collecting patient data for a patient. The method involves obtaining patient data for the patient and storing patient data on a server, accessing patient data from the server using an electronic device, analyzing accessed patient data to generate a patient analysis, and performing a patient care function based on the patient analysis and modifying patient data, if the patient analysis mandates the action.

In general, in one aspect, the invention relates to an apparatus for collecting patient data for a patient. The apparatus includes means for obtaining a patient data for the patient and storing the patient data on a server, means for accessing the patient data from the server using an electronic device, means for analyzing the accessed patient data to generate a patient analysis, and means for performing a patient care action based on the patient analysis and modifying patient data, if the patient analysis mandates the action.

In general, in one aspect, the invention relates to a computer system for collecting patient data for a patient. The computer system includes a processor, a memory, a storage device, and software instructions. The software instructions are stored in the memory for enabling the computer system under control of the processor, to obtain patient data for the patient and storing patient data on a server, access patient data from the server using an electronic device, analyze accessed patient data to generate a patient analysis, and perform a patient care function based on the patient analysis and modifying patient data, if the patient analysis mandates the action.

Other aspects and advantages of the invention will be apparent from the following description and the appended claims.

### BRIEF DESCRIPTION OF DRAWINGS

FIG. 1 shows a flow diagram of currently used communications network for home health care systems or care management groups.

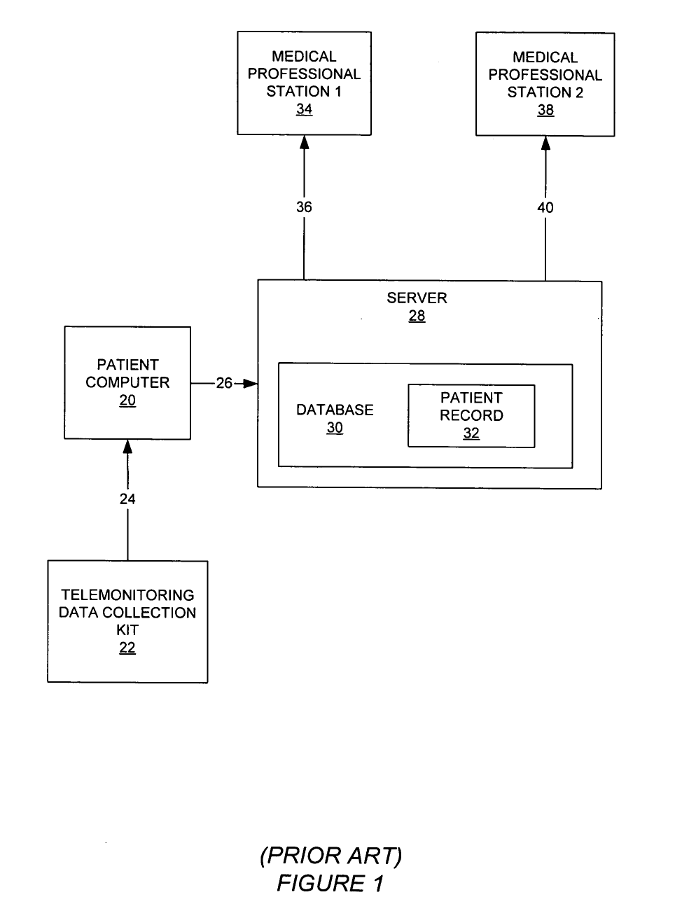

FIG. 2 shows a flowchart of events in an in-home health care environment.

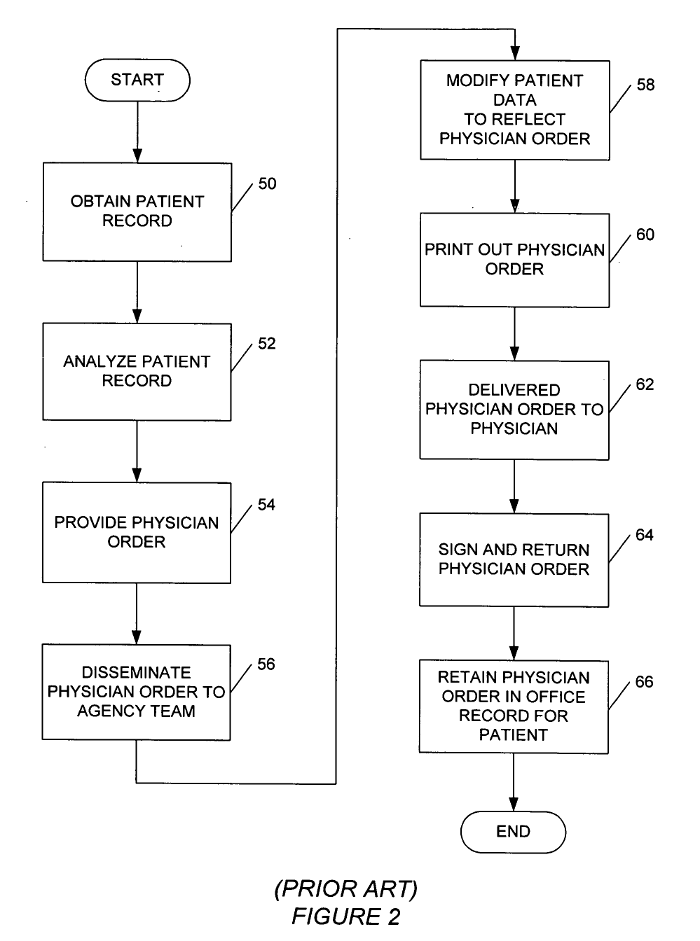

FIG. 3 shows a typical networked computer system.

FIG. 4 shows a flow diagram of a health care system in accordance with an embodiment of the invention.

FIG. 5 shows a computer screen shot of a web browser displaying a login screen for the physician module in accordance with an embodiment of the invention.

FIG. 6 shows a computer screen shot of a web browser displaying an interface for a patient module in accordance with an embodiment of the invention.

FIG. 7 shows a computer screen shot of a physician module web browser application in accordance with an embodiment of the invention.

FIG. 8 shows an interface for a health care system interface in accordance with an embodiment of the invention.

FIG. 9 shows a flowchart of a health care system in accordance with an embodiment of the invention.

### DETAILED DESCRIPTION

Specific embodiments of the invention will now be described in detail with reference to the accompanying figures. Like elements in the various figures are denoted by like reference numerals for consistency.

In the following detailed description of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

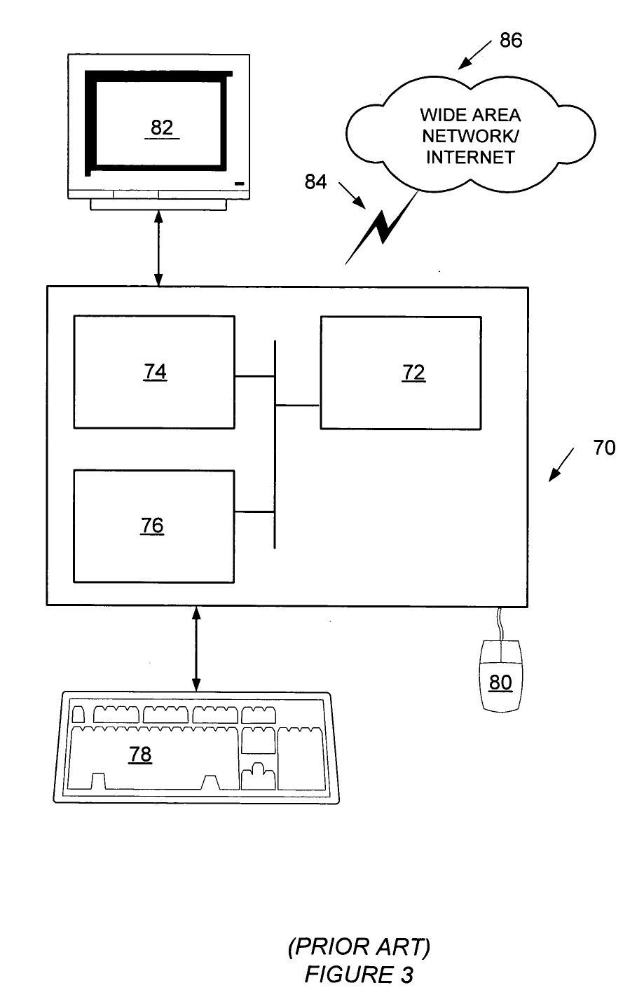

The invention may be implemented on virtually any type computer regardless of the platform being used. For example, as shown in FIG. 3, a typical computer system (70) includes a processor (72), an associated memory (74), a storage device (76), and numerous other elements and functionalities typical of today's computers (not shown). The computer system (70) may also include input means, such as a keyboard (78) and a mouse (80), a touch screen pen (or stylus) (not shown), a microphone (not shown), a digital computer camera (not shown), and an output device, such as a monitor or touch screen (82). Those skilled in the art will appreciate that these input and output means may take other forms. The computer system (70) may be connected via a network connection (84) to a Wide Area Network (WAN) (86), such as the internet.

The invention relates to a system and method for collecting and managing patient data within the health care industry. While the examples and descriptions found within this document focus on the home health care industry, this invention is applicable to the entire health care industry and should in no way be limited to only the home health care industry.

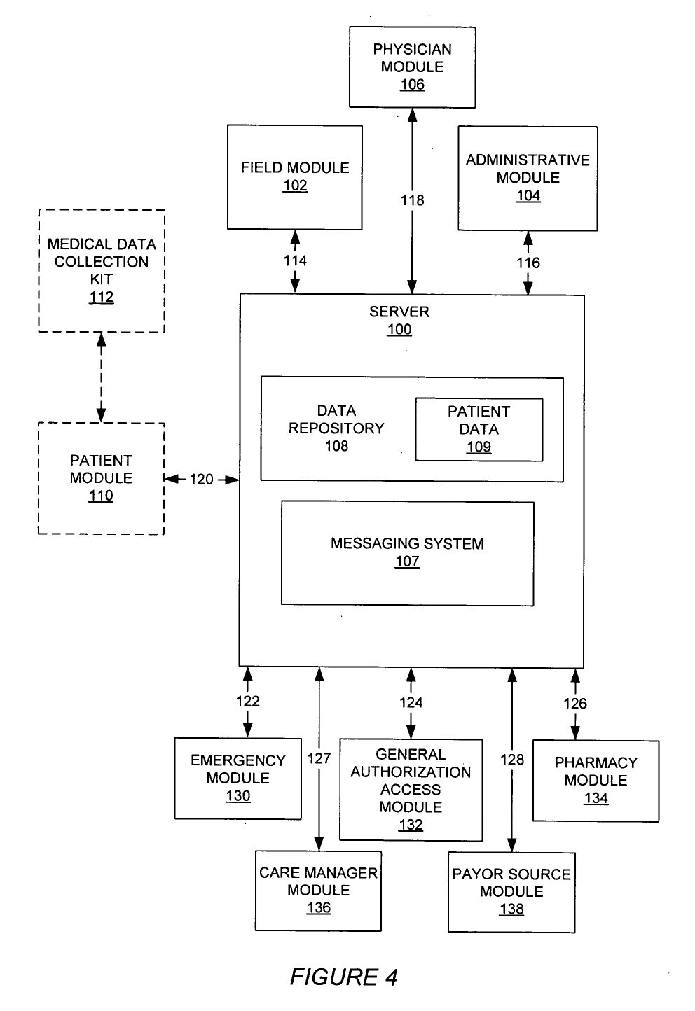

FIG. 4 shows a flow diagram for a health care system in accordance with one or more embodiments of the invention. A server (100) may be connected to various modules (that may act as either modules or sub-modules, as appropriate), including a field module (102), an administrative module (104), a physician module (106), a patient module (110), an emergency module (130), a pharmacy module (134), a care manager module (136), a payor source module (138), and a general authorized access module (132). Each of the modules discussed above may be connected via one or more network links (114, 116, 118, 120, 122, 124, 126, 127, 128) that may be wireless Internet connections using various wireless or Internet protocols, or Internet connections using telephone lines, fiber optic lines, cable modems, satellite links, global positioning systems (GPS), cellular connectivity, Wi-Fi networks, or other appropriate media. One skilled in the art can appreciate that while several modules and network links are listed above, the present invention is capable of using additional modules and network links that help collect and manage patient data, as described herein. Accordingly, the list provided above should not serve to limit this invention.

The field module (102), the administrative module (104), and the physician module (106) are software programs, web-based platforms, and/or interfaces executing on an electronic device with the ability to connect through a network link, such as a conventional personal computer (PC), a handheld or mobile computing device (e.g., personal digital assistant (PDA)), a laptop computer, a tablet PC, a web-enabled cellular phone, a pager, a GPS receiver, etc. Optionally, in one embodiment of the invention, the patient module (110) is configured to perform a patient care function on the patient data using such devices as the medical collection kit (112), as necessary.

A messaging system (107), in accordance with an embodiment of the invention, is software residing on the server (100), or distributed to the field module (102), the administrative module (104), the physician module (106), and/or the patient module (110) or other available modules (acting as modules or sub-modules). The messaging system (107) may be used by the health care team to send messages to appropriate parties. Further, the messaging system (107) is enabled through use of operating system Application Programming Interfaces (API's) (such as the Microsoft Windows™ API) to interactively communicate within a software program and between multiple software programs, interfaces, and platforms. For example, the messaging system (107) is enabled to use an operating system API to send a notification message to appropriate parties whenever the patient data is modified. Specifically, a notification message may be sent when a patient's vital sign (as received by the server) is out of regular range, when a physician enters a new order for intervention in a patient care, or when a new patient has been admitted. Each of these events may trigger a different form of customized message that is appropriate for the person and condition involved. For example, an out-of-range vital sign alert may involve a code or text message received on a personal pager, a cell phone, or a popup message on a computer screen. To send such messages, the messaging system (107) may use well-known Instant Messaging (IM) protocols (e.g., Wireless Village™, MSN Messenger™, Yahoo™, Jabber™, AOL™, etc.).

In one embodiment of the invention, a data repository (108), which includes patient data (109), is resident on the server (100). The data repository (108) may be physically located separate from the server (100). Further, the data repository (108) may reside on an Active Server Pages™ (ASP) server. Further, in one embodiment of the invention, a mirror data repository may be used for automatic default backup.

Patient data (109) may include such data as a patient record, a schedule of interventions, and a tracking of activities that took place in the patient medical record, which is date timed, and marked by author (or editing person) to ensure authentication and safeguarding of information. The patient record may include such items as biographical data, physiological data, medical history, insurance information, a plan of care, a patient admission information, a patient's legal consent agreements for health care intervention information exchange and payments, a patient comprehensive assessments, clinical notes, progress notes, lab results, a communication and messaging log, a medication profile, a patient activity report, a patient's self-reported notes, etc. The schedule of interventions may include such items as past and future clinical staff on-site visits, physician office visits, and consultations with health care staff and other medical personnel. The patient data (109) may be stored as a variety of formats, such as text, audio, and video files. The patient data (109) may be encrypted, in an embodiment of the invention.

The field module (102) collects data for a patient of the health care agency via a clinical field staff person, such as a nurse, a therapist, etc. The data may be transferred to the server (100), and to the data repository (108), to be included in the patient data (109). Multiple types, formats and forms of data may be collected using the field module (102), and the data may be sent to the database over the wireless network (114). For example, the data may be sent in encrypted binary form using a secure form of Hypertext Transfer Protocol (e.g., HTTPS) and 128-bit Secure Socket Layer (SSL) encryption techniques to ensure patient confidentiality.

A common scenario involves a user, such as the field staff person, typing patient care notes (e.g., therapy notes relating to a recent home visit with the patient) into the field module (102). Further, pictures and multimedia (e.g., video or sound) may be collected and transferred to the field module (102). For example, a nurse may visit the patient at the patient's home, gather physiological data and images (e.g., digital pictures of a wound) and numerically quantifiable health parameters (e.g., blood pressure, audio from a medical test, such as a stethoscope reading, numerical measurements of the patient's movement capabilities (e.g., range of limb motion), etc.). The nurse may use an appropriate tool to facilitate gathering patient data and uploading the data to the repository.

Because the network link connecting the field module (102) to the server (100) may be wireless, the field module (102) may be used to collect patient data from multiple locations (with or without connections to the network) and send the data to the server (100) for storage in the data repository (108). For example, the data may be collected at a patient's residence where a connection to the server is not available, and later uploaded to the server (100) at a different location (e.g., the nurse's car, the nurse's residence, the health care agency office, etc.). Soon thereafter, the data is accessible to other users via the data repository (108). In one embodiment of the invention, an electronically designed valve is configured to transfer information between the field module (102) and the data repository (108). This valve allows data to be sent and received from server (100) or wait on the hand held device until it is determined that internet connectivity is available.

In one embodiment of the invention, the user of the field module (102) will, at all times, have a complete patient chart on a handheld PC that represents an exact replica of the chart located on the server whether connected online through a network link or temporarily offline. This functionality is possible because of the automatic creation of a local data folder on the handheld PC should online connectivity weaken or disappear altogether. The nurse or therapist is able to access patient medical record and view (on a tablet personal computer, for example) a medical chart from the patient data (109) while the nurse is examining the patient at the patient's residence that does not permit internet connectivity. Further, the nurse may use access guidelines and treatment protocols available on the system for treating the patient. For example, the guideline may guide the nurse through the process of removing an infusion line or providing specific data about foot care for a diabetic patient. Documentation of the intervention in the patient care is standardized in such a way that permits any licensed nurse to follow the same exact procedure and document the action by the same exact chosen words with little or no previous experience of the patient or that type of procedure or intervention. The standardization of documentation, saves time, gives confidence, allow the nurse and the agency to remain in compliance with professional standards while providing appropriate and quality care for the patient.

Continuing with FIG. 4, the administrative module (104) provides managers and office support team (i.e., administrative personnel of the health care agency) the capability to access patient data in the data repository (108), and perform all the necessary in-office functions to maintain an efficiently run health care operation. For example, the administrative module (104) may be used to handle in-office functions, such as setting up videoconferences between medical professionals and patients; maintaining payroll accounts; maintaining billing accounts; maintaining employee credentials and work hours; receiving and entering new referrals; scheduling patient visits; receiving and entering lab results and other pertinent information; communication with anyone involved in the care of the patient; modifying built-in database as needed; generating clinical, financial, and statistical reports; documenting and monitoring patient progress; monitoring quality control of practice along with documentation and compliance with regulatory standards; receiving screen alerts and other forms of alerts about patients unusual data and disseminating messages to appropriate parties; accessing telemonitoring data; tracking the usage of the system by authorized users; and receiving alerts of unauthorized use of the system. Depending on the level of access authorization, an administrative module user can operate and access every other module directly from an office computer. One skilled in the art will appreciate that the administrative module (104) may be accessed from any location where WAN connectivity an authorized user token exists.

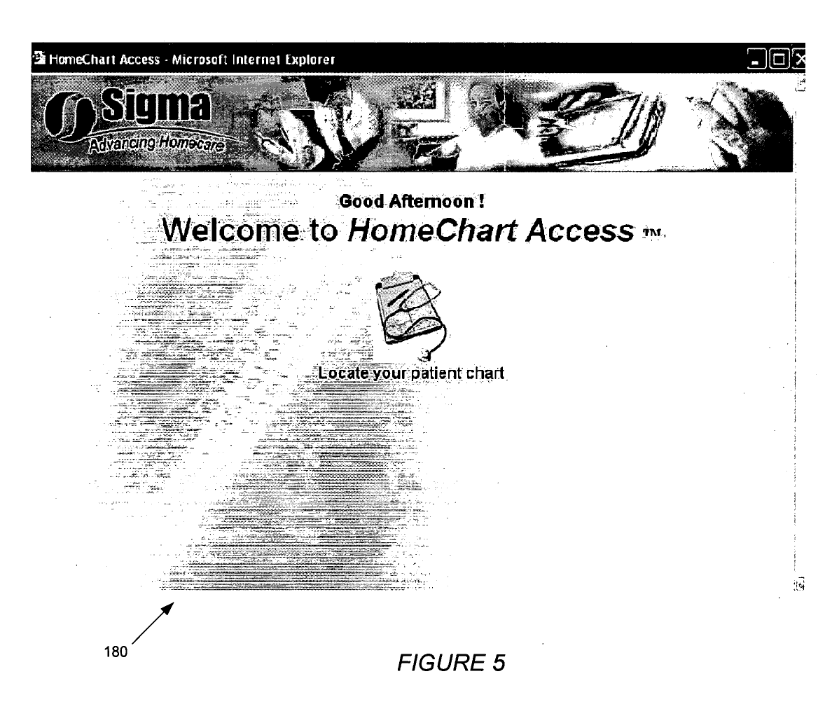

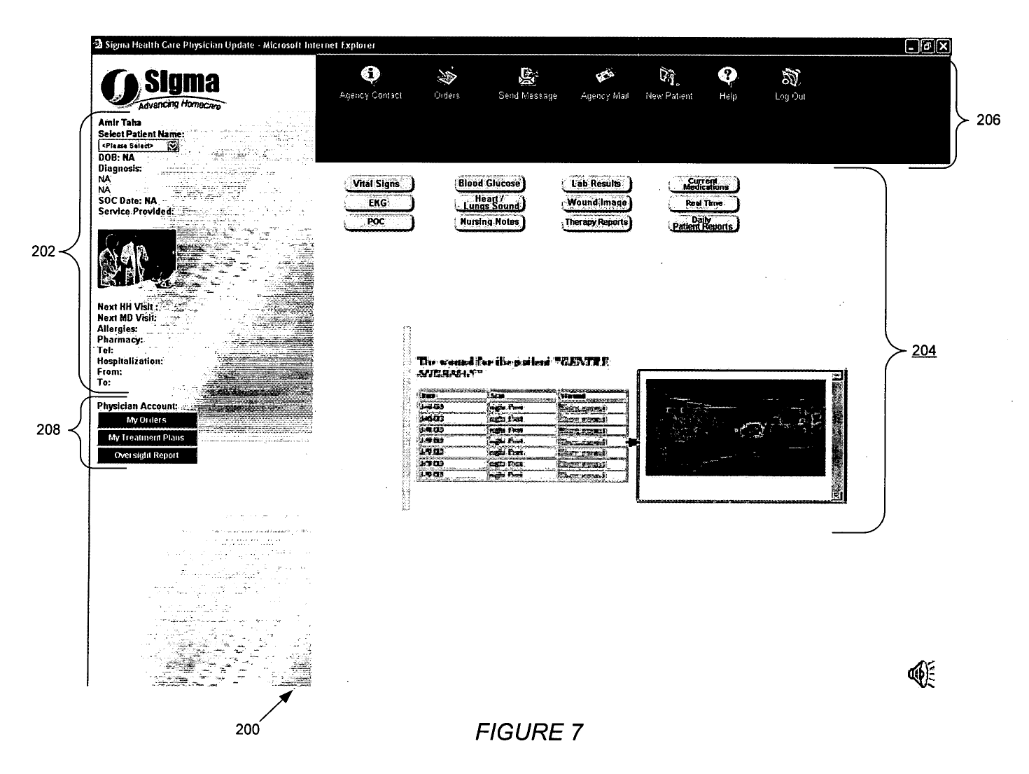

The physician module (106) may be used by a user, such as a physician or other medical personnel, to perform a variety of patient care functions. In one embodiment of the invention, FIG. 5 shows a computer screen shot of a web browser (180) displaying a login screen for the physician module (106), while FIG. 7 shows a interface (200) for the physician module (106) (which is described in detail below).

Returning to FIG. 4, as the network link (118) for the physician module (106) may be wireless, it may be used in multiple locations (as required by the physician or other authorized users) in order to care for the patient. Not only may the physician (or other authorized users) access and review the patient data (109) from the data repository (108), but the physician may use the physician module (106) to modify the patient data (109) and store modified patient data (109) in the data repository (108). The physician may also use the physician module (106) to send messages or physician orders to relevant personnel (such as users of the administrative module (104), or the field module (102)) using a messages function and a physician order function.

In one embodiment of the invention, the physician may conduct a visit with the patient via a videoconference with the patient using telemonitoring equipment. Appropriate telemonitoring equipment may include two web cams and cabling, with videoconferencing software (e.g., Net Messenger™) operating on both the electronic device used by the physician module (106) and the patient module (112). For example, the physician may access the patient's physiological data such as the patient's blood pressure, in real time, using telemonitoring remote control. In this case, a three-way conference may also occur as the agency nurse and/or fixed nurse may be attending the conference on his or her own field module (102) and/or administrative module (104).

In addition to physicians, other individuals involved in a patients' health care may access necessary information found in the physician module (106) using various module or sub-modules (depending on level of access) specifically formatted for a particular industry's needs. For instance, a pharmacy module (134) may allow an authorized pharmacist to use the patient authorized pharmacy access code to access a patient's medication profile while working at a commercial pharmacy. In addition, the pharmacist may update the patient's profile to new medications and refills as well as receive instant messages and prescriptions from the physician for such medication. Similarly an emergency module (130) may be used by an authorized health professional in an emergency room (ER) to access relevant patient information from the ER by using the ER patient authorized access code. A case manager module (136) may be used by authorized case management organizations to access patient information. Also, the payor source module (138) may allow authorized payor sources to view patient information, including clinical notes in a read-only format. Additionally, the general authorization access module (132) allows access to the modules with very limited access for any authorized users.

Access codes and authorizations to view patient information by parties who are involved in patients' health care can either be permanently given by pre-associating these entities with the patient medical record or by a temporary access authorized by the patient. The patient can be given temporary access via a PIN number given to patient. The PIN number may be provided on a special identification card that also includes special instructions for a first time user on how to connect to a patient medical record. The patient is able to use a patient module (110) (or patient PC) to allow access. This may also take place by using a card scanner or other available methods for verifying patient identification.

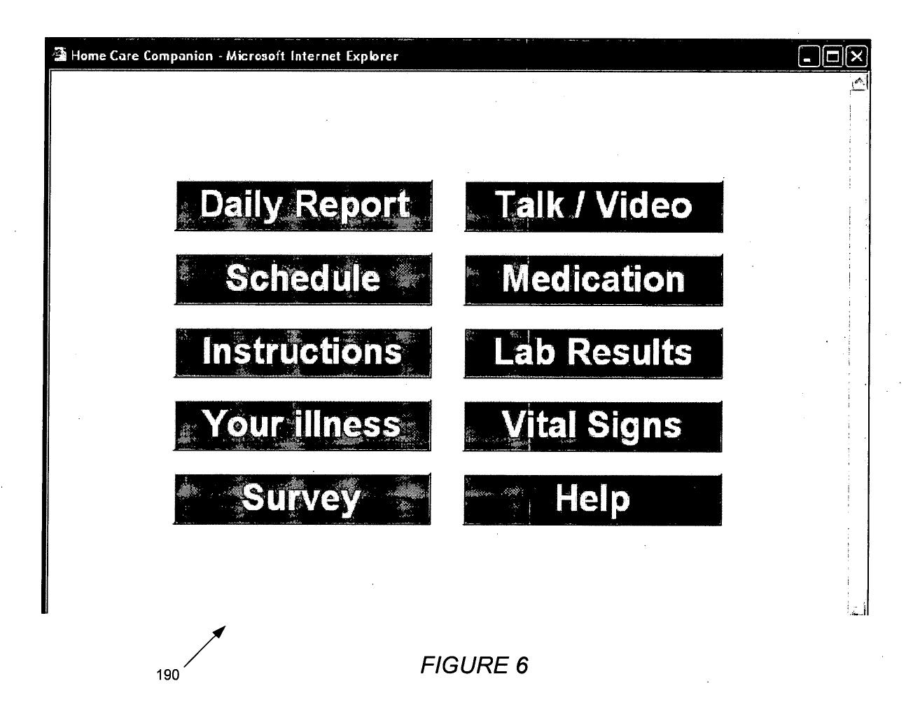

Optionally, in an embodiment of the invention, the health care system includes a patient module (110) and a medical data collection kit (112), as shown in FIG. 4. In one embodiment of the invention, FIG. 6 shows a computer screen shot of a web browser (190) displaying an interface for the patient module (110).

Continuing with FIG. 4, the patient module (110) may be a patient PC or other form of PC connected to the medical data collection kit (112), which is also optional. A variety of commercial medical data collection kits are available for use, and the patient module (110) uses multiple communications protocols in order to use a variety of commercial medical data collection kits. The patient module (110) may interface with the medical data collection kit (112) via a Universal Serial Bus (USB) and/or serial and parallel ports of the electronic device on which the patient module (110) resides. Various other communication protocols may be used to connect to the collection kit (112), such as blue tooth connectivity, radio frequency (RF) connectivity, infrared (IR) connectivity, or WiFi connectivity. The patient module (110) may be connected to the server (100) via a network link (120). Further, the network link (120) may be an Internet connection using telephone lines, fiber optic lines, cable modems, satellite links, GPS systems, cellular connectivity, Wi-Fi networks, etc.

Via the medical data collection kit (112), the patient module (110) can obtain real-time physiological data, such as blood pressure, glucose level, EKG readings, peak flow, body weight, body temperature, stethoscope audio, digitized images, blood glucose reading, blood prothrombin time reading etc. Also, videoconferencing is facilitated through the addition of a video camera, such as a web cam, and suitable software, such as Microsoft's Net Meeting™. Thus, the patient can communicate with the agency and the physician or other authorized users in real time. Multiple users can conference with the patient at the same time. Further, the patient can use the patient module (110) to provide daily self-assessment procedures, which can guide the patient through a set of disease-specific questions and/or actions, the results of which may be uploaded to the data repository (108). Undesirable answers trigger the messaging system to send messages in different forms (e.g., pop-up screens, pager or cell phone messages, etc.) to the people involved in the care.

FIG. 7 shows a computer screen shot of a physician module web application (200) which may display patient data on an electronic device in accordance with an embodiment of the invention. The web application (200) includes four distinct sections, namely general patient information (202), specific patient health data and parameters (204), a formal communication domain (206) with the health agency, and a physician domain (208) for physician-only use to allow access to specific reports and the ability to electronically sign records.

Once a specific patient is chosen, the general patient information section (202) displays general patient data regarding the specified patient, such as the patient date of birth, the patient diagnosis, the start date of care by the health care agency, the type of visits and services provided, the date of the next scheduled agency visit or contact, the name and phone number of the patient's pharmacy, patient medication allergies, the date of the next doctor visit, and hospitalization dates, if any.

Displayed within the specific patient information section (204) of the web application (200) are several labeled action buttons. Each of the action buttons gives vital information about a patient's ongoing health status. The vital patient data is collected via several manners, including an on-site health professional documented visit on field module. Information may be provided from the patient module through a telemonitoring visit, by a patient's own self-reporting, or by the medical data collection kit connected to the patient module. Data may also be provided by a third party entities, such a medical laboratory running tests, another physician or health consultant involved in the care, a radiologist, or a pharmacist who updates medication profile for the patient. A mixture of this data is re-displayed on the specific patient information section (204) of the physician module web application (200) in the form of tables, graphs, and electronic files (such as video, image, and/or sound files) reflecting the time and date of the patient's given health status. Within the specific patient information section (204), access to historical patient data and the ability to view combined or related functional patient data is available. For example, a patient's blood pressure over a several hour/day period could be compared on a single graph or the sound of the heart could be easily compared over time.

The following patient data may be collected (regardless of where or how collected, e.g., in a lab, at home, by a nurse, by patient) and displayed in the specific patient information section (204): blood pressure/pulse, blood glucose, lab/self-testing results, patient weight, patient temperature, EKG results, oxygen level, peak flow, nursing narratives, therapy visit notes, progress notes and reports, images of patient's injury or x-rays, heart/lung/abdomen sound or voice of the patient, daily patient report showing patient self reporting and answers to several question related to diagnosis, patient medications, and patient plan of treatment. Specifically in FIG. 7, the specific information section (204) shows an image of a patient's sore and a chart allowing access to historical images of the same sore. Therefore, the medical professional is able to view the related functional patient data over time to show therapy progress (or lack thereof) and modify patient care accordingly.

Within the formal communication domain (206) section of the web application (200) are hyperlinks associated with agency contact, orders, messages, mail, new patients, help, and log out features. The <agency contact> feature displays agency information when needing contact information. The <orders> feature allows physicians to write or view an order, sign it electronically by authenticated signature, send the order instantly to the health care agency, and modify the patient chart. The order is then automatically distributed to the entire health care team involved in the case immediately through the messaging system (as described above in FIG. 4). The <send message> feature is available to physician and other clinicians to communicate with each other when analyzing patient data or discussing a specific health occurrence. Messages are instantly deposited in the patient chart and become part of the medical record and can be viewed at any time by any authorized person. The <agency mail> feature provides a secure e-mailing capability to an authorized person for receiving and sending messages unrelated to a specific patient chosen from the drop-down patient list. The <new patient> feature provides an instant electronic forward for a new patient referral that can be alerted immediately to an intake/admission coordinator. The <help feature> allows the user to access explanations about the use and functionality of the web application (200). The <log out> feature allows the user to safely and securely exit the physician module web application (200).

The physician domain (208) allows physicians to access special reports (both signed and unsigned), medical updates, and listing of various other documents related to all (or any portion of) physician's patients and also making the documents available for batch review and signature when required by the health care agency.

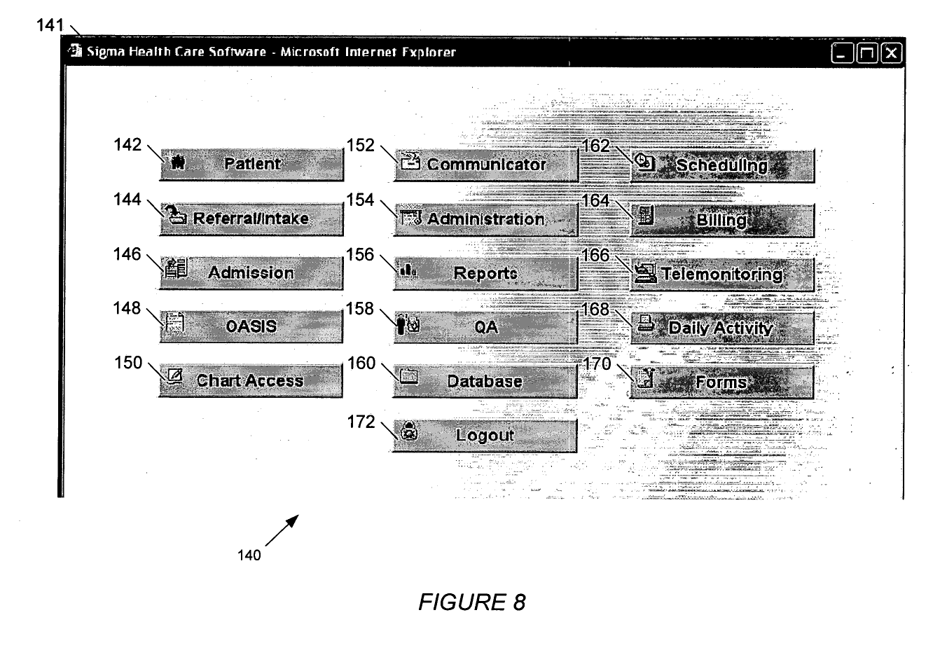

FIG. 8 shows a web interface (140) for a health care system in accordance with an embodiment of the invention. The web interface (140) provides access to a variety of functions accessed by the field and the administrative modules (as shown in FIG. 4 above). In accordance with an embodiment of the invention, the web interface (140) may be presented as a Graphical User Interface (GUI) within the context of a web application accessed over a network link. However, one skilled in the art will appreciate that the application is equally capable of being viewed using technology other than just a web application, e.g., a stand-alone executable program, on a terminal of a distributed system, etc.

The web interface (140) includes a title bar graphic (141) indicating the type of software system, and multiple clickable buttons (e.g., 142-172) each representing a particular function available to the users of the field and administrative modules. In accordance with an embodiment of the invention, the clickable buttons represent an interface to perform particular functions. Also, users of the field module may interface with a portion of the functions of the web interface (140) using the communications network links, depending on the needs of the users of each of the field module.

In accordance with one embodiment of the invention, functions included on web interface (140) include patient (142), referral/intake (144), admission (146), OASIS (148), chart access (150), communicator (152), administrator (154), reports (156), quality assurance (Q/A) (158), database (160), scheduling (162), billing (164), telemonitoring (166), daily activity (168), forms (170), and log out (172).

The patient function (142) links the user to the patient information in the data repository from which all information available for a selected patient may be viewed and new information may be entered. Information fields accessible from the patient function include: full patient chart contents or separately listed documents that include initial referral information, case conferences, visit notes, missed visits, assessments, care plans, physician orders, communications, evaluations, medication profile, lab results and scheduled labs, supplies, vital parameters, schedule, episode cost analysis, and a map to the patient's residence or location. These information fields may be accessed for review or may be accessed to input new information, such as a new visit note, lab result, or assessment.

The referral/intake function (144) includes a template used to admit referred patients to the health care agency. The referral/intake function (144) also includes functionality to inherit data from a previous admission, and to convert orders for a patient to physician orders.

The admission function (146) has a template for admitting new patients to the health care agency. In accordance with an embodiment of the invention, a new admission based on a referral may inherit patient data from the referral. For example, a patient may give biographical data during enrollment; also, the patient may have medical records data that was received as part of the referral process. Such data associated with the referral is inherited into the patient data for the patient.

The OASIS function (148) provides the ability to create reports of OASIS (Outcome and Assessment Information Set) activity. OASIS is an assessment tool utilized in home care to generate reports for a proper governmental entity. For example, reports may be generated by the start-of-care dates that have not been transmitted to the state authorities. Using the OASIS function (148), the user may also perform actions such as creating OASIS transmittal files.

The chart access function (150) provides field and administrative users a template for accessing the physician module. The chart access function (150) allows the user to view vital data for a patient on a single screen, e.g., the patient record, clinical assessments for the patient, plan of care, medication profile, on-site visit text notes, next-scheduled visit, next physician visit, etc.

The communicator function (152) provides a template for a secure e-mail system that only allows an exchange of messages between either authorized users and/or patients. Messages may be patient-specific and may be prompted from a patient record or may be created independently.

The administrator function (154) provides a template for performing assorted administrative tasks. For example, access and editing capability for personnel files is available, as is access and editing power for database information. Other capabilities include setting agency preferences indicating certain software used and setting parameters customized to each specific agency. Certain administrative reports may also be generated including reports of expired or missing human resources documents, remote log-in reports, and risk management reports. The administrator module (154) may also use a physician order function (not shown) to access orders generated by physicians caring for patients enrolled with the agency. Physician orders may also be generated by a user of the administrative module by taking a physician order over the telephone. Any physician order, in accordance with an embodiment of the invention, once generated, is sent to each appropriate user of the system via a network link. The messaging system is invoked to send the physician's order to each appropriate user.

The reports function (156) provides the ability to generate reports, such as benchmarking and statistical, clinical, operational and financial reports.

The Quality Assurance (QA) function (158) provides a template for improving quality of the health care agency. For example, audit reports on various aspects of care may be performed in order to prepare future corrective action. Aspects of care that may be used to generate audit reports include patient outcomes, adverse events (such as injuries), therapy progress reports, etc.

The database function (160) enables administrative access to the data repository. This includes, among other things, access to the agency's database of physician information, employee information, and clinician user group information. From the employee database, for example, administrative tasks related to payroll, health insurance, etc. may be executed.

The scheduling function (162) provides a template for generating and modifying a schedule for the patient. Also, the scheduling function (162) provides for scheduling on-site visits (at the patient's residence), remote visits, laboratory tests, etc. For scheduling on-site visits, the scheduling function (162), in accordance with an embodiment of the invention, may be configured to send notifications of such visits to particular employees upon login of such employees. Additionally, the scheduling function (162) is configured to take certain actions (e.g., send notification messages) when visits are not made in conformance to regulatory standards.

For purposes of compliance with regulatory standards, e.g., governmental rules and regulations, the scheduling function (162) provides software functionality to count actual visits versus scheduled visits and generate a record of actual visits versus scheduled visits. The scheduling function (162) then generates a message to interested users that indicates missed visits.

The scheduling function (162) also maintains a timeline for the patient with respect to regulations pertaining to therapy re-evaluation, episode re-certification, as well as supervisory visits needed for nursing aides, Licensed Practical Nurses (LPN's), and therapy assistants. Furthermore, the scheduling function (162) provides for laboratory test scheduling, and for user-customizable reminder tools, e.g., a user calendar.

The billing function (164) is used for generating insurance payments, posting of accounts receivable, billing reports, and interfacing with payroll software.

The telemonitoring function (166) is used for setting up patient modules, and accessing data deposited from patient module or connecting to patient modules medical data collection kit optionally connected to the electronic device Video from a video camera or other video device may also be accessed using the telemonitoring function (166). Data from the medical data collection kit (or video) is connected to the server via the network communications link. Using the telemonitoring function (166), videoconferencing between nurses, physicians, the patient, and other staff may be accomplished.

The daily activity function (168) provides a capability to generate and display a list of any document executed by any module connected to the data repository. This function (168) also allows for a quick audit of all daily activities. The daily activity function (168) provides the ability to view reports of activity by date range. These reports include pending and/or complete assessments, visit notes, and lab tests. Additionally, reports may include physician orders viewed by categories including pending, received, signed, or unsigned.

The forms function (170) provides access to forms utilized by agency staff such as teaching tools to be used with patients, orientation forms for new personnel, and any other forms that an agency might desire to be accessible from the application.

The logout function (172) allows the user to safely and securely exit the web interface (140 of the home health care system.

Referring back to FIG. 4, the field module (102), the administrative module (104) may interface with each of the functions of the web interface (140 in FIG. 8), or a portion of the functions, in accordance with the particular needs of users. When using the field module (102), the field staff is only able to see information regarding those patients for which they are scheduled to visit. When using the administrative module (104), staff is able to see information regarding each and every patient of the agency. Likewise, field staff is not be able to see the schedule of the other staff in the field; however the administrative office staff is able to see the information using the administrative module (104).

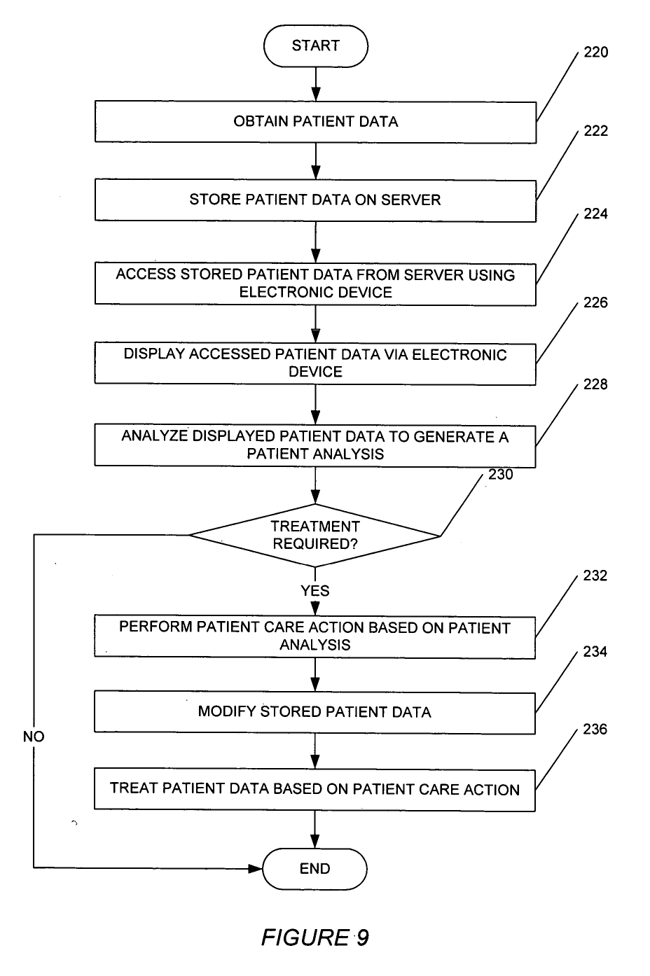

Multiple specific actions particular to many health care situations may be performed using the health care system shown in FIGS. 4-8. FIG. 9 shows a flowchart of a health care system in accordance with an embodiment of the invention. A first action is obtaining patient data (Step 220). The patient data may be obtained in a variety of ways and from a variety of places, such as by telephone, by videoconference, or by data entry. For example, a nurse may visit a patient, admit the patient, and generate the patient data using the field module and the admission function to obtain the pertinent admission data from the patient. The nurse may obtain patient data such as physiological data (e.g., blood pressure) at the patient's residence, or the nurse may take notes on a PDA, tablet PC or other electronic data collection devices (on which the field module resides). Also, the nurse may use a device such as a videophone, camera-phone, or digital camera to take pictures of the patient (or patient wounds, etc.), and such images may become part of the patient data. The patient data may be in a variety of formats (e.g., AVI files, jpg files, .txt files, .doc files, wav etc.).

Once the patient data has been obtained, the patient data is stored on the server (Step 222). Typically, the field module, the administrative module, the physician module, and/or the patient module may be used to upload the patient data to the server. In accordance with an embodiment of the invention, the field module, the administrative module, the physician module or the patient module use the network link and a secure communications protocol (such as Transport Control Protocol/Internet Protocol (TCP/IP)) to facilitate data transfer between the server and one of the modules. A web application interface may be used to present template functionalities and clickable buttons in order to guide users of the field module, the administrative module, the physician module or the patient module through the process of uploading the patient data to the server. Once the patient data is uploaded to the server, the patient data is stored in the data repository.

Then, once the patient data is stored, the patient is accessed using an electronic device (Step 224). For example, a physician in charge of patient care may use her/his own PC or a handheld computer on which the physician module can be accessed to exchange information with the server.

The accessed patient data is then displayed via the electronic device (Step 226). For example, the physician may use chart display software (such as Microsoft Excel™) executing on the handheld computer to display the patient charts. Alternatively, the physician may use appropriate hardware to transfer the accessed patient data to a desktop computer for display or printing. The displayed patient data is then analyzed to generate a patient analysis (Step 228). For example, a physical therapist may analyze the displayed patient data in order to determine what improvement/progress has or has not been made a patient.

A determination is then made (based on the patient analysis) as to whether a treatment is required (Step 230). If the analysis indicates that no treatment is required, no patient care function is performed (although some administrative functions may still be required). Otherwise, a patient care function is may be required based on the patient analysis. For example, after reviewing patient notes, indicating extreme discomfort and signs of a spreading infections, the physician may determine that the patient requires medication.

If a treatment is required, a patient care action is performed based on the patient analysis (Step 232). For example, the physician may generate a physician order changing the patient's medication regimen. In accordance with an embodiment of the invention, the physician uses the physician order function of the physician module to generate the physician order.

Once the patient care action has been performed, the patient data is modified accordingly (Step 234). For example, the physician order template, in accordance with an embodiment of the invention, includes a “Send Physician Order” template button, which the physician clicks causing communication over a WAN or wireless network link to the server and the physician order is added to the patient data. Further, the messaging system is triggered to send a message to appropriate parties, such as a nurse in charge of the patient, and/or to a pharmacist.

The patient is then treated based on the patient action (Step 236). For example, the pharmacy receives a prescription (sent as an authenticated message via the pharmacy module (134 in FIG. 4)) and delivers the medication to the patient. The network link is used to upload the data to the server, where the data is stored on the database in the patient record.

Although the flowchart in FIG. 9 terminates after Step 236, those skilled in the art will appreciate that treatment and care of the patient may be performed on an ongoing basis potentially requiring this process to be repeated numerous times.

The present invention affords the following advantages. Patients who are under the care of a physician or a team of health care professionals and reside and function in their own communities (i.e., un-institutionalized, yet requiring skilled health care and monitoring) can benefit from this invention by being closely monitored and can receiving timely intervention, as if the patient is receiving care by the same team in an institutionalized setting. The present invention not only reduces the cost of health care for those patients and their health care payor source, the system maintains the quality of health care practiced without forcing the patient to appear for treatment at a particular time and place (which often creates an obstacle to care for many patients).

Further, the present invention takes advantage of technology, such as Internet connectivity, wireless communications, instant messaging, mobile devices, and handheld electronic devices in order to offer fast, real time updates and notifications relating to a patient's condition and instant update of medical records. Specifically, the use of single database (SDB) and automated IM notification of a newly authenticated physician order, nursing assessment, lab results, instant deposit of communication by other people involved in the care, pharmacist refill of medications, or patient self-monitoring environment eliminate possible lag time between findings and intervention.

The invention reduces multiple human interference in transmitting messages and duplicate data entry. This reduces the compromise of information and thereby minimizes errors and keeps agencies in regulatory compliance. Additionally, time and effort are minimized and the practice of patient care is streamlined with the least amount risk involved. The invention increases accountability, yet provides a safe haven and confidence by guiding new practitioners, thereby reducing the impact of the current nursing shortage. Because all modules are web-enabled, access may be gained 24/7 anytime, anywhere.

Because staff is traveling long distances and patients are scattered throughout a wide area, saving staff time allows for increased productivity and greater focus on providing the appropriate care needed for patients.

Furthermore, by allowing physicians secured electronic writing and signature of orders, the physician is better able to manage time and cost while keeping patient information more accessible on an on-demands basis. For example, the ability to sign aggregated physician orders electronically promotes quicker, more cost effective health care.

Furthermore, by making a secured electronic writing of orders and signing available to physicians, the physician is better able to manage time and cost, yet keep patient information more accessible on an on-demands basis. For example, the ability to sign aggregated physician orders electronically promotes quicker, less expensive health care.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A health care system, comprising:
a field module configured to gather a first portion of patient data and to send the first portion of patient data to a server;
an administrative module configured to perform a plurality of functions on patient data; and
a physician module configured to display patient data and perform a patient care function.

2. The system of claim 1, further comprising:
a patient module configured to gather a second portion of patient data at a patient location and send the second portion of patient data to the server.

3. The system of claim 2, wherein the first portion and the second portion of the patient data is gathered by an on-site health care professional.

4. The system of claim 2, wherein the field module, the administrative function, the physician module, and the patient module execute on a plurality of computer systems.

5. The system of claim 2, further comprising:
a telemonitoring medical kit used by the patient module for gathering the second portion of patient data.

6. The system of claim 2, wherein at least one selected from the group consisting of the field module, the administrative module, the physician module, and the patient module communicates with the server via a single network link.

7. The system of claim 6, wherein the single network link comprises at least one selected from the group consisting of Internet connectivity, wireless connectivity, and wired telephone line connectivity.

8. The system of claim 1, wherein the patient care function comprises modifying the patient data.

9. The system of claim 1, wherein the physician module is configured to display patient data.

10. The system of claim 1, wherein the physician module comprises at least one sub-module to perform functions requiring varied levels of access.

11. The system of claim 1, wherein the physician module is configured to interface with at least one other module to perform functions requiring varied levels of access.

12. The system of claim 1, wherein the physician module is configured to modify patient data.

13. The system of claim 1, wherein the physician module is configured to be accessible on an on-demand and an as-needed basis.

14. The system of claim 1, wherein the patient care function comprises aggregating a plurality of physician orders.

15. The system of claim 1, wherein the patient data is available at a plurality of locations and at any time of day.

16. The system of claim 1, wherein the physician module is configured to communicate with the patient via a network link using the patient module.

17. The system of claim 16, wherein the physician module is configured to communicate with the patient module using conferencing.

18. The system of claim 17, wherein conferencing comprises at least one selected from the group consisting of videoconferencing, audio conferencing, and teleconferencing.

19. The system of claim 1, further comprising:
a messaging system configured to send a message.

20. The system of claim 19, wherein the message system is configured to send the message when the patient care function is performed.

21. The system of claim 19, wherein the message system is configured to send the message when patient data indicates an unusual health event occurs.

22. The system of claim 19, wherein the message system is configured to send the message when a function is performed by at least one of the group consisting of the administration module, the field module, the physician module, and the patient module.

23. The system of claim 22, wherein the function is the execution of a document.

24. The system of claim 22, wherein the message system is configured to send the message using an alert to a communication device.

25. The system of claim 24, wherein the alert is a text message with sound and the communication device is a pager.

26. The system of claim 24, wherein the alert is a pop-up screen with sound and the communication device is a personal computer.

27. The system of claim 24, wherein the alert is an alphanumeric message with sound and the communication device is a cellular phone.

28. A method of collecting patient data for a patient, comprising:
obtaining patient data for the patient and storing patient data on a server;
accessing patient data from the server using an electronic device;
analyzing accessed patient data to generate a patient analysis; and
performing a patient care function based on the patient analysis and modifying patient data, if the patient analysis mandates the action.

29. The method of claim 28, further comprising:
treating the patient based on the patient care analysis.

30. The method of claim 28, further comprising:
sending a message from a message system when the patient care function is performed.

31. The method of claim 28, further comprising:
performing a function on patient data by an office administration team.

32. The method of claim 31, further comprising:
sending a message from a message system when the function is performed.

33. The method of claim 28, further comprising:
displaying the accessed patient data on the electronic device.

34. The method of claim 28, further comprising:
visiting the patient at a patient location;
obtaining referral data for the patient from the server; and
admitting the patient into a health care agency at the patient location using patient data and referral data.

35. The method of claim 28, wherein patient data is modified using a physician module to generate a patient care action.

36. The method of claim 35, wherein the patient care action comprises dissemination of a scheduled event via the physician module using a network link.

37. The method of claim 28, wherein the patient care action conforms to a regulatory standard.

38. The method of claim 37, wherein the patient care action comprises aggregating a plurality of physician orders.

39. The method of claim 35, wherein the physician module comprises at least one sub-module to perform functions requiring varied levels of access.

40. The method of claim 35, wherein the physician module is configured to interface with at least one other module to perform functions requiring varied levels of access.

41. The method of claim 35, wherein the physician module is configured to be accessible on an on-demand and an as-needed basis.

42. The method of claim 35, wherein patient data is available at a plurality of locations and at any time of day.

43. The method of claim 35, wherein the physician module is configured to communicate with the patient via a network link using a patient module.

44. The method of claim 43, wherein the physician module is configured to communicate with the patient module using conferencing.

45. The method of claim 44, wherein conferencing comprises at least one selected from the group consisting of videoconferencing, audio conferencing, and teleconferencing.

46. The method of claim 28, further comprising:
accessing the patient data using a temporary access.

47. An apparatus for collecting patient data for a patient, comprising:
means for obtaining a patient data for the patient and storing the patient data on a server;
means for accessing the patient data from the server using an electronic device;
means for analyzing the accessed patient data to generate a patient analysis; and
means for performing a patient care action based on the patient analysis and modifying patient data, if the patient analysis mandates the action.

48. The apparatus of claim 47, further comprising a means for accessing the patient data using a temporary access.

49. A computer system for collecting patient data for a patient, comprising:
a processor;
a memory;
a storage device; and
software instructions stored in the memory for enabling the computer system under control of the processor, to:
obtain patient data for the patient and storing patient data on a server;
access patient data from the server using an electronic device;
analyze accessed patient data to generate a patient analysis; and
perform a patient care function based on the patient analysis and modifying patient data, if the patient analysis mandates the action.
